(19) United States
(12) Patent Application Publication
(10) Pub. No.: US 2024/0261172 A1
(43) Pub. Date: Aug. 8, 2024

(54) AIRWAY CLEARANCE SYSTEM

(71) Applicant: Electromed, Inc., New Prague, MN (US)

(72) Inventors: Steven PLAGER, Eden Prairie, MN (US); Yoshi Kasahara, New Prague, MN (US)

(73) Assignee: Electromed, Inc., New Prague, MN (US)

(21) Appl. No.: 18/434,647

(22) Filed: Feb. 6, 2024

Related U.S. Application Data
(60) Provisional application No. 63/443,678, filed on Feb. 6, 2023.

(51) Int. Cl. A61H 9/00

(52) U.S. Cl. CPC A61H 9/0007; A61H 9/0078; A61H 2201/1238; A61H 2201/1621; A61H 2201/165; A61H 2201/501; A61H 2201/5046; A61H 2201/5084; A61H 2205/084

(57) ABSTRACT

A medical device operable with a thoracic therapy garment to apply repetitive compression forces to the body of a person to aid blood circulation, loosen and eliminate mucus from the lungs and trachea and relieve muscular and nerve tensions is provided. More specifically, an airway clearance system comprising an air pulsator coupled to a therapy garment to apply pressure and repetitive compression forces to a body of a person is provided. The air pulsator has a touchscreen control panel with a graphical user interface for facilitating user programming of therapies. The air pulsator further has connectivity for monitoring compliance and device data.

### CROSS-REFERENCE TO RELATED APPLICATIONS

The present disclosure claims priority to U.S. Provisional Application No. 63/443,678, entitled AIRWAY CLEARANCE SYSTEM, and filed Feb. 6, 2023, the content of which is hereby incorporated by reference.

### FIELD OF THE INVENTION

A medical device operable with a thoracic therapy garment to apply repetitive compression forces to the body of a person to aid blood circulation, loosen and eliminate mucus from the lungs and trachea and relieve muscular and nerve tensions is provided. More specifically, an airway clearance system comprising an air pulsator coupled to a therapy garment to apply pressure and repetitive compression forces to a body of a person is provided. The air pulsator has a touchscreen control panel with a graphical user interface for facilitating user programming of therapies. The air pulsator further has connectivity for monitoring compliance and device data.

### BACKGROUND OF THE INVENTION

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Clearance of mucus from the respiratory tract in healthy individuals is accomplished primarily by the body's normal mucociliary action and cough. Under normal conditions these mechanisms are very efficient. Impairment of the normal mucociliary transport system or hypersecretion of respiratory mucus results in an accumulation of mucus and debris in the lungs and can cause severe medical complications such as hypoxemia, hypercapnia, chronic bronchitis and pneumonia. These complications can result in a diminished quality of life or even become a cause of death. Abnormal respiratory mucus clearance is a manifestation of many medical conditions such as pertussis, cystic fibrosis, atelectasis, bronchiectasis, cavitating lung disease, vitamin A deficiency, chronic obstructive pulmonary disease, asthma, immotile cilia syndrome and neuromuscular conditions. Exposure to cigarette smoke, air pollutants and viral infections also adversely affect mucociliary function. Post surgical patients, paralyzed persons, and newborns with respiratory distress syndrome also exhibit reduced mucociliary transport.

Chest physiotherapy has had a long history of clinical efficacy and is typically a part of standard medical regimens to enhance respiratory mucus transport. Chest physiotherapy can include mechanical manipulation of the chest, postural drainage with vibration, directed cough, active cycle of breathing and autogenic drainage. External manipulation of the chest and respiratory behavioral training are accepted practices. The various methods of chest physiotherapy to enhance mucus clearance are frequently combined for optimal efficacy and are prescriptively individualized for each patient by the attending physician.

HFCWO systems are used for applying pressure and repetitive pulses to a person's thorax for secretion and mucus clearance therapy. Respiratory mucus clearance is applicable to many medical conditions, such as pertussis, cystic fibrosis, atelectasis, bronchiectasis, cavitating lung disease, vitamin A deficiency, chronic obstructive pulmonary disease, asthma, and immobile cilia syndrome. Post-surgical patients, paralyzed persons, and newborns with respiratory distress syndrome have reduced mucociliary transport. The pulsator 10 provides high frequency chest wall oscillations or pulses to enhance mucus and airway clearance in a person with reduced mucociliary transport. High frequency pressure pulses subjected to the thorax in addition to providing respiratory therapy to a person's lungs and trachea, also stimulates the heart and blood flow in arteries and veins in the chest cavity. Muscular and nerve tensions are also relieved by the repetitive pressure pulses imparted to the front, sides, and back portions of the thorax. The lower part of the thoracic cage comprises the abdominal cavity which reaches upward as high as the lower tip of the sternum so as to afford considerable protection to the large and easily injured abdominal organs, such as the liver, spleen, stomach, and kidneys. The abdominal cavity is only subjected to very little high frequency pressure pulses.

Person care homes, assisted living facilities, and clinics can accommodate a number of persons in different rooms or locations that require respiratory therapy or high frequency chest wall oscillations as medical treatments. In such instances, a device such as a pedestal may be used to support an HFCWO pulsator such that it can be manually moved to required locations.

Cystic fibrosis (CF) is the most common inherited life-threatening genetic disease among Caucasians. The genetic defect disrupts chloride transfer in and out of cells, causing the normal mucus from the exocrine glands to become very thick and sticky, eventually blocking ducts of the glands in the pancreas, lungs and liver. Disruption of the pancreatic glands prevents secretion of important digestive enzymes and causes intestinal problems that can lead to malnutrition. In addition, the thick mucus accumulates in the lung's respiratory tracts, causing chronic infections, scarring, and decreased vital capacity. Normal coughing is not sufficient to dislodge these mucus deposits. CF usually appears during the first 10 years of life, often in infancy. Until recently, children with CF were not expected to live into their teens. However, with advances in digestive enzyme supplementation, anti-inflammatory therapy, chest physical therapy, and antibiotics, the median life expectancy has increased to 30 years with some patients living into their 50s and beyond. CF is inherited through a recessive gene, meaning that if both parents carry the gene, there is a 25 percent chance that an offspring will have the disease, a 50 percent chance they will be a carrier and a 25 percent chance they will be genetically unaffected. Some individuals who inherit mutated genes from both parents do not develop the disease. The normal progression of CF includes gastrointestinal problems, failure to thrive, repeated and multiple lung infections, and death due to respiratory insufficiency. While some persons experience grave gastrointestinal symptoms, the majority of CF persons (90 percent) ultimately succumb to respiratory problems.

Virtually all persons with CF require respiratory therapy as a daily part of their care regimen. The buildup of thick, sticky mucus in the lungs clogs airways and traps bacteria, providing an ideal environment for respiratory infections and chronic inflammation. This inflammation causes permanent scarring of the lung tissue, reducing the capacity of the lungs to absorb oxygen and, ultimately, sustain life. Respiratory therapy must be performed, even when the person is feeling well, to prevent infections and maintain vital capacity. Traditionally, care providers perform Chest Physical Therapy (CPT) one to four times per day. CPT consists of a person lying in one of twelve positions while a caregiver “claps” or pounds on the chest and back over each lobe of the lung. To treat all areas of the lung in all twelve positions requires pounding for half to three-quarters of an hour along with inhalation therapy. CPT clears the mucus by shaking loose airway secretions through chest percussions and draining the loosened mucus toward the mouth. Active coughing is required to ultimately remove the loosened mucus. CPT requires the assistance of a caregiver, often a family member but a nurse or respiratory therapist if one is not available. It is a physically exhausting process for both the CF person and the caregiver. Patient and caregiver non-compliance with prescribed protocols is a well-recognized problem that renders this method ineffective. CPT effectiveness is also highly technique sensitive and degrades as the giver becomes tired. The requirement that a second person be available to perform the therapy severely limits the independence of the CF person.

Persons confined to beds and chairs having adverse respiratory conditions, such as CF and airway clearance therapy, are treated with pressure pulsating devices that subject the person's thorax with high frequency pressure pulses to assist the lung breathing functions and blood circulation. The pressure pulsating devices are operatively coupled to thoracic therapy garments adapted to be worn around the person's upper body. In hospital, medical clinic, and home care applications, persons require easy application and low cost disposable thoracic garments connectable to portable air pressure pulsating devices that can be selectively located adjacent the left or right side of the persons.

Artificial respiration devices for applying and relieving pressure on the chest of a person have been used to assist in lung breathing functions, and loosening and eliminating mucus from the lungs of CF persons. Subjecting the person's chest and lungs to pressure pulses or vibrations decreases the viscosity of lung and air passage mucus, thereby enhancing fluid mobility and removal from the lungs. An example of a body pulsating method and device disclosed by C. N. Hansen in U.S. Pat. No. 6,547,749, incorporated herein by reference, has a case accommodating an air pressure and pulse generator. A handle pivotally mounted on the case is used as a hand grip to facilitate transport of the generator. The case including the generator must be carried by a person to different locations to provide treatment to individuals in need of respiratory therapy. These devices use thoracic therapy garments having air-accommodating air cores that surround the chests of persons. Examples of garments used with a body pulsating device is disclosed by C. N. Hansen and L. J. Helgeson in U.S. Pat. Nos. 6,676,614 and 7,374,550. The garment is used with an air pressure and pulse generator. Mechanical mechanisms, such as solenoid or motor-operated air valves, bellows and pistons are disclosed in the prior art to supply air under pressure to diaphragms and bladders in regular pattern or pulses. Manually operated controls are used to adjust the pressure of the air and air pulse frequency for each person treatment and during the treatment. The garment worn around the thorax of the CF person repeatedly compresses and releases the thorax at frequencies as high as 25 cycles per second. Each compression produces a rush of air through the lobes of the lungs that shears the secretions from the sides of the airways and propels them toward the mouth where they can be removed by normal coughing. Examples of chest compression medical devices are disclosed in the following U.S. Patents.

W. J. Warwick and L. G. Hansen in U.S. Pat. Nos. 4,838,263 and 5,056,505 disclose a chest compression apparatus having a chest vest surrounding a person's chest. A motor-driven rotary valve located in a housing located on a table allows air to flow into the vest and vent air therefrom to apply pressurized pulses to the person's chest. An alternative pulse pumping system has a pair of bellows connected to a crankshaft with rods operated with a DC electric motor. The speed of the motor is regulated with a controller to control the frequency of the pressure pulses applied to the vest. The patient controls the pressure of the air in the vest by opening and closing the end of an air vent tube. The apparatus must be carried by a person to different locations to provide treatment to persons in need of respiratory therapy.

M. Gelfand in U.S. Pat. No. 5,769,800 discloses a cardiopulmonary resuscitation system having a pneumatic control unit equipped with wheels to allow the control unit to be moved along a support surface.

N. P. Van Brunt and D. J. Gagne in U.S. Pat. Nos. 5,769,797 and 6,036,662 disclose an oscillatory chest compression device having an air pulse generator including a wall with an air chamber and a diaphragm mounted on the wall and exposed to the air chamber. A rod pivotally connected to the diaphragm and rotatably connected to a crankshaft transmits force to the diaphragm during rotation of the crankshaft. An electric motor drives the crankshaft at selected controlled speeds to regulate the frequency of the air pulses generated by the moving diaphragm. A blower delivers air to the air chamber to maintain a positive above atmospheric pressure of the air in the chamber. Controls for the motors that move the diaphragm and rotate the blower are responsive to the air pressure pulses and pressure of the air in the air chamber. These controls have air pulse and air pressure responsive feedback systems that regulate the operating speeds of the motors to control the pulse frequency and air pressure in the vest. The air pulse generator is a mobile unit having a handle and a pair of wheels.

C. N. Hansen in U.S. Pat. No. 6,547,749 also discloses a body pulsating apparatus having diaphragms operatively connected to a motor to generate air pressure pulses directed to a thoracic therapy garment that subjects a person's body to high frequency pressure forces. A first manual control operates to control the speed of the dc motor to regulate the frequency of the air pressure pulses. A second manual control operates an air flow control valve to adjust the pressure of the air directed to the garment thereby regulating the garment pressure on the person's body. An increase or decrease of the speed of the motor changes the frequency of the air pressure pulses and the vest pressure on the person's body. The second manual control must be used by the person or caregiver to adjust the garment pressure to maintain a selected garment pressure.

C. N. Hansen, P. C. Cross and L. H. Helgeson in U.S. Pat. No. 7,537,575 discloses a method and apparatus for applying pressure and high frequency pressure pulses to the upper body of a person. A first user programmable memory controls the time of operation of a motor that operates the apparatus to control the duration of the supply of air under pressure and air pressure pulses to a thoracic therapy garment located around the upper body of the person. A second user programmable memory controls the speed of the motor to regulate the frequency of the air pressure pulses directed to the garment. A manual operated air flow control valve adjusts the pressure of air directed to the garment thereby regulating the garment pressure on the person's upper body. An increase or decrease of the speed of the motor changes the frequency of the air pressure pulses and changes the garment pressure on the person's upper body. The manually operated air flow control valve must be used by the person or caregiver to maintain a selected garment pressure. The garment pressure is not programmed to maintain a selected garment pressure.

N. P. Van Brunt and M. A. Weber in U.S. Pat. No. 7,121,808 discloses a high frequency air pulse generator having an air pulse module with an electric motor. The module includes first and second diaphragm assemblies driven with a crankshaft operatively connected to the electric motor. The air pulse module oscillates the air in a sinusoidal waveform pattern within the air chamber assembly at a selected frequency. A steady state air pressure is established in the air chamber with a blower driven with a separate electric motor. A control board carries electronic circuitry for controlling the operation of the air pulse module. Heat dissipating structure is used to maximize the release of heat from the heat generated by the electronic circuitry and electric motors.

### BRIEF SUMMARY OF THE INVENTION

The following presents a simplified summary of one or more embodiments of the present disclosure in order to provide a basic understanding of such embodiments. This summary is not an extensive overview of all contemplated embodiments, and is intended to neither identify key or critical elements of all embodiments, nor delineate the scope of any or all embodiments.

The invention relates to a medical device operable with a thoracic therapy garment to apply repetitive compression forces to the body of a person to aid blood circulation, loosen and eliminate mucus from the lungs and trachea and relieve muscular and nerve tensions.

In one embodiment, a high frequency chest wall oscillation system comprising a therapy garment, a pulsator for creating air pulses having a frequency and a pressure, and a single hose coupling the pulsator to the therapy garment for communicating air pulses from the pulsator to the therapy garment is provided. The pulsator includes an air pulse generator for creating air pulses having a frequency and a pressure; and a control panel comprising a touchscreen having a display. The user programs a therapy using the touchscreen. The therapy may be a Program Therapy or a Ramp Therapy. In some embodiments, the user labels the therapy as a Good Day Therapy or a Bad Day Therapy via the touchscreen.

The display has an orientation and may be customizable to a user. The pulsator may further comprise an accelerometer and orientation of the display may be adjusted based on readings from the accelerometer. The pulsator may further comprise an ambient light sensor. The touchscreen has a brightness and the brightness can be automatically adjusted based on sensed ambient light

The system may further comprise a mobile app. Device data may be collected during treatment using the high frequency chest wall oscillation system. The air pulsator may communicate the collected device data to a server, such as cloud storage. Such communication may be directly from the pulsator or may be via an intermediary such as the mobile app. In some embodiments, the collected device data may be stored on one or both of the pulsator or the mobile app.

The pulsator may further include a housing having an inlet vent and an outlet vent, the housing encasing the air pulse generator provided in a case, a circuit board, a fan, and a motor. Airflow channel gasketing is provided around a circumference of the case, the airflow channel gasketing defining an airflow pathway. The airflow pathway may be through the inlet vent, over the case along a first side of the airflow channel gasketing, along the circuit board, over the motor, over the case along a second side of the airflow channel gasketing, and out the outlet vent.

In a further embodiment, a high frequency chest wall oscillation system comprising a therapy garment, a pulsator for creating air pulses having a frequency and a pressure, and a single hose coupling the pulsator to the therapy garment for communicating air pulses from the pulsator to the therapy garment, and a mobile app is provided. The control panel comprises a display, wherein a user programs a therapy using the touchscreen. The pulsator has wireless connectivity. During treatment using the high frequency chest wall oscillation system, various data may be collected. The pulsator may communicate the collected data to the mobile app and or to a server. The collected data may be displayed to a user via the mobile app, on a display of the pulsator, on a computer via a web application, or other.

In some embodiments, a web application may be provided. A medical professional can use the web application to store information on a server, such as cloud storage, such that it can be downloaded to the HFCWO system, directly or through the mobile app.

The collected data may be compliance data. The compliance data may include how often the system is being used and the therapy being used. The device data may include fault codes and/or troubleshooting information.

The mobile app may be provided on a mobile device. The mobile app may include a remote control interface and the mobile device may be used as a remote control. The mobile app may include a remote control interface and wherein the remote control interface is specific to a type of user of the mobile app. When the type of user of the mobile app is a patient, the remote control interface enables the user to start the therapy, stop the therapy, pause the therapy, and review device status. When the type of user of the mobile app is a medical professional, the remote control interface enables the user to change settings, communicate prescriptions, communicate instructions, and set a new therapy.

The mobile app may remind a user to use the high frequency chest wall oscillation system. The mobile app may coordinate with another device to gather health information about a user of the high frequency chest wall oscillation system, wherein the other device measures at least one vital sign including body temperature, pulse rate, respiratory rate, blood pressure, and blood oxygen levels.

In some embodiments, the user labels the therapy as a Good Day Therapy or a Bad Day Therapy via the touchscreen, and the device data includes occurrences of good days and bad days based on therapy selected for use. Saved therapies and saved therapy labels may be stored at the device, in the mobile app, or at a server.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the invention will be better understood from the following description taken in conjunction with the accompanying Figures, in which:

FIG. 1a illustrates a high frequency chest oscillations (HFCWO) system, in accordance with one embodiment.

FIG. 1b illustrates a movable pedestal 29 for supporting a pulsator, in accordance with one embodiment.

FIG. 2a illustrate a top, front handle side view of a pulsator, in accordance with one embodiment.

FIG. 2b illustrate a top, front hose side view of a pulsator, in accordance with one embodiment.

FIG. 3a illustrates a side view of a hose side of a pulsator, in accordance with one embodiment.

FIG. 3b illustrates a side view of a handle side of a pulsator, in accordance with one embodiment.

FIG. 4 illustrates a front view of a pulsator, in accordance with one embodiment.

FIG. 5a illustrates a first back perspective view of a pulsator, in accordance with one embodiment.

FIG. 5b illustrates a second back perspective view of a pulsator, in accordance with one embodiment.

FIG. 5c illustrates a third back perspective view of a pulsator, in accordance with one embodiment.

FIG. 6a illustrates a top view of a pulsator, in accordance with one embodiment.

FIG. 6b illustrates a bottom view of a pulsator, in accordance with one embodiment.

FIG. 7 illustrates a menu screen of a user interface, in accordance with one embodiment.

FIG. 8 illustrates a series of user interface screens displayed on a touchscreen for setting a therapy, in accordance with one embodiment.

FIG. 9 illustrates a series of user interface screens displayed on a touchscreen for starting a Program Therapy, in accordance with one embodiment.

FIG. 10 illustrates a series of user interface screens displayed on a touchscreen for setting a therapy, in accordance with one embodiment.

FIG. 11 illustrates a series of user interface screens displayed on a touchscreen for starting a Ramp Therapy, in accordance with one embodiment.

FIG. 12 illustrates a series of user interface screens displayed on a touchscreen for Manual Mode, in accordance with one embodiment.

FIG. 13 illustrates a user interface screen displayed on a touchscreen for editing a therapy, in accordance with one embodiment.

FIG. 14 illustrates a user interface screen for storing a therapy to back up and restoring a therapy from back up, in accordance with one embodiment.

FIG. 15 illustrates a diagram of an HFCWO system including an associated mobile app, in accordance with one embodiment.

FIG. 16 illustrates a thoracic therapy garment located around a thorax of a person, in accordance with one embodiment.

FIG. 17 is an enlarged sectional view of a right side of the thoracic therapy garment of FIG. 16 on a thorax of a person, in accordance with one embodiment.

FIG. 18 illustrates a diagram of a programmable control system for an air pulse generator, in accordance with one embodiment.

FIG. 19 illustrates an air pulse generator in use with displacer in an open position, in accordance with one embodiment.

FIG. 20 illustrates an air pulse generator in use with displacers in a closed position, in accordance with one embodiment.

FIG. 21a illustrates a perspective view of a pulsator with a top wall of a housing shown transparent, in accordance with one embodiment.

FIG. 21b illustrates a pulsator with a top wall of a housing removed, in accordance with one embodiment.

FIG. 21c illustrates an alternate perspective view of a pulsator with a top wall of a housing removed, in accordance with one embodiment.

FIG. 21d illustrates a top view of a pulsator with a top wall removed, in accordance with one embodiment.

FIG. 21e illustrates a top perspective view of a pulsator with a top wall removed, in accordance with one embodiment.

FIG. 22a illustrates a first view of a fan of a pulsator, in accordance with one embodiment.

FIG. 22b illustrates a second view of a fan of a pulsator, in accordance with one embodiment.

FIG. 23a illustrates a circuit board of a pulsator, in accordance with one embodiment.

FIG. 23b illustrates a close up of a circuit board and heat sinks, in accordance with one embodiment.

FIG. 23c illustrates aspects of a circuit board, in accordance with one embodiment.

FIG. 24a illustrates a stepper valve, in accordance with one embodiment.

FIG. 24b illustrates an alternative view of a stepper valve, in accordance with one embodiment.

FIG. 25a illustrates a dampening tube, in accordance with one embodiment.

FIG. 25b illustrates an alternative view of a dampening tube, in accordance with one embodiment.

FIG. 26a illustrates components provided within the housing, in accordance with one embodiment.

FIG. 26b illustrates components provided within the housing, in accordance with one embodiment.

### DETAILED DESCRIPTION

A medical device operable with a thoracic therapy garment to apply repetitive compression forces to the body of a person to aid blood circulation, loosen and eliminate mucus from the lungs and trachea and relieve muscular and nerve tensions is provided. More specifically, an airway clearance system comprising an air pulsator coupled to a therapy garment to apply pressure and repetitive compression forces to a body of a person is provided. The air pulsator has a touchscreen control panel with a graphical user interface for facilitating user programming of therapies. The air pulsator further has connectivity for monitoring compliance and device data.

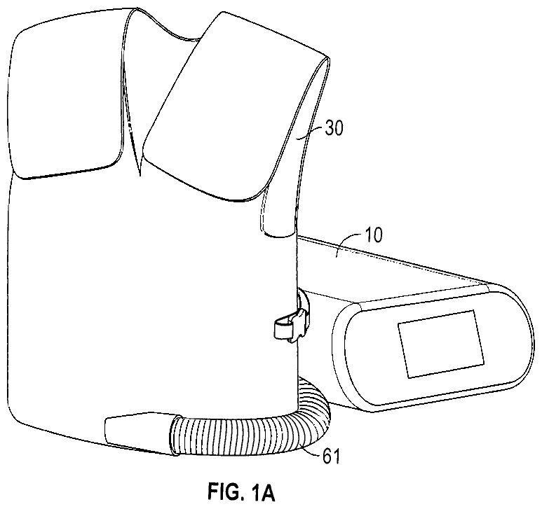

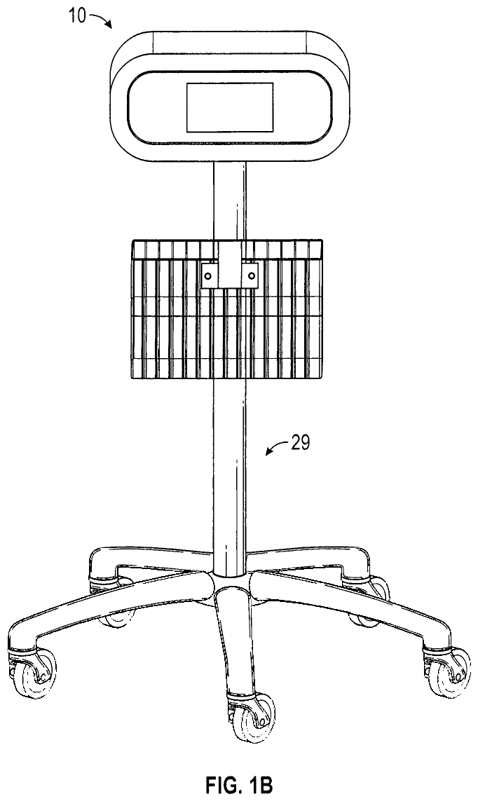

FIG. 1a illustrates a high frequency chest oscillations (HFCWO) system, in accordance with one embodiment. The HFCWO system provides an effective form of airway clearance therapy, creating a squeeze and release action around the chest and torso of a user from about 5 to about 20 times per second. The HFCWO system includes a portable pulsator 10, a thoracic therapy garment 30, and a hose 61. In some embodiments, only a single hose is provided as part of the system. The HFCWO system may further include a mobile app and/or a web app. The mobile app can provide data storage and wireless connectivity to communicate data collected by the pulsator to a server. In alternative embodiments, the pulsator may save collected data directly to a server.

The pulsator 10 comprises an air pulse generator having a housing. The thoracic therapy garment 30 may be worn around a person's thorax for applying pressure and air pulses. In various embodiments, the thoracic therapy garment 30 may be a vest or a wrap. The hose 61 may be flexible and is couplable to the portable pulsator 10. Air pulses from the air pulse generator in the portable pulsator 10 are communicated to the therapy garment 30 via the hose 61. The therapy garment 30 inflates via the hose and delivers rapidly repeating air pulses that gently squeeze and release the upper body of the user. The squeeze and release action of the HFCWO treatment simulates respiratory therapy or CPT, which are effective to shear mucus away from the walls of a lung's airways, reduce the viscosity of secretions, and propel mucus toward larger airways where it can be expectorated or suctioned.

FIG. 1b illustrates a movable pedestal 29 for supporting the pulsator, in accordance with one embodiment. The pedestal allows respiratory therapists and patient care persons to transport the pulsator to different locations accommodating a number of persons in need of respiratory therapy and to storage locations. Pulsator 10 can be separated from pedestal 29 and used to provide respiratory therapy to portions of a person's body. The pedestal may have a telescoping height or a static height.

The pulsator may be equipped with wireless connectivity such that the pulsator may communicate device information and usage information to a mobile app or similar device which can upload the usage information to storage, such as cloud storage. The device and usage information can be reviewed for compliance data, fault codes, to troubleshoot the HFCWO system, and the like.

To use the HFCWO system, a user puts on the therapy garment, connects the therapy garment to the pulsator via the hose, and starts a therapy using the control panel touchscreen. The HFCWO system can apply a plurality of therapies. The therapies generally comprise applying air pulses having specified pressure and frequency to the thorax of the user. The pressure and frequency can be varied during a therapy. Specific therapy modes include program mode, ramp mode, and manual mode. The control panel touchscreen can be used to program desired therapies, described more fully below.

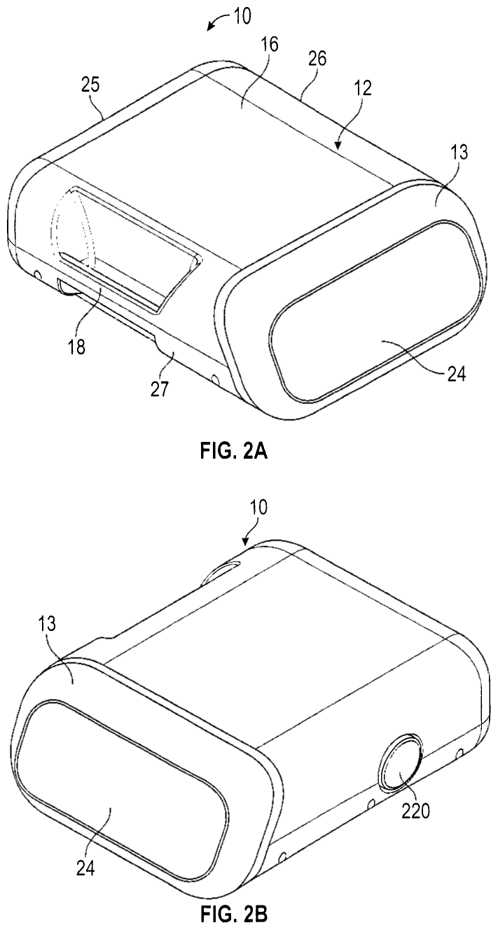

FIGS. 2a and 2b illustrate top, front side views of the pulsator. FIG. 2a illustrates the handle side of the pulsator while FIG. 2b illustrates the hose connector side of the pulsator. In the embodiment shown, the housing 12 is a generally rectangular member having a front wall 13 and side walls 26 and 27, a top wall 16, a back wall 25, and a bottom wall. A display and control panel is provided on the front wall 13. In the embodiment shown, the display and control panel are integral in a touchscreen 24. In some embodiments, a handle 18 may be provided. In the embodiment shown, a handle 18 is provided along the side wall 27. The handle 18 can be used to manually carry the pulsator 10. A hose outlet 220 for receiving a hose 220 may be provided along any surface. Air may be forced from a pump within the pulsator through a hose outlet, through the hose, and into a therapy garment worn by a user. In the embodiment shown, the hose outlet is provided along a side wall. Feet 230 for stabilizing the pulsator 10 on a surface may be provided along a support wall of the housing. In the embodiment shown, the support wall is the bottom wall. In other embodiments, the feet may be provided along another wall, may be provided along more than one wall, or may not be provided.

While the pulsator is shown in a horizontal orientation, the orientation of the housing and pulsator may be varied. More specifically, the orientation of the pulsator 10 during therapy may be varied between vertical and horizontal. In such embodiments, an accelerometer may be provided to detect the orientation of the pulsator and adjust orientation of the display accordingly.

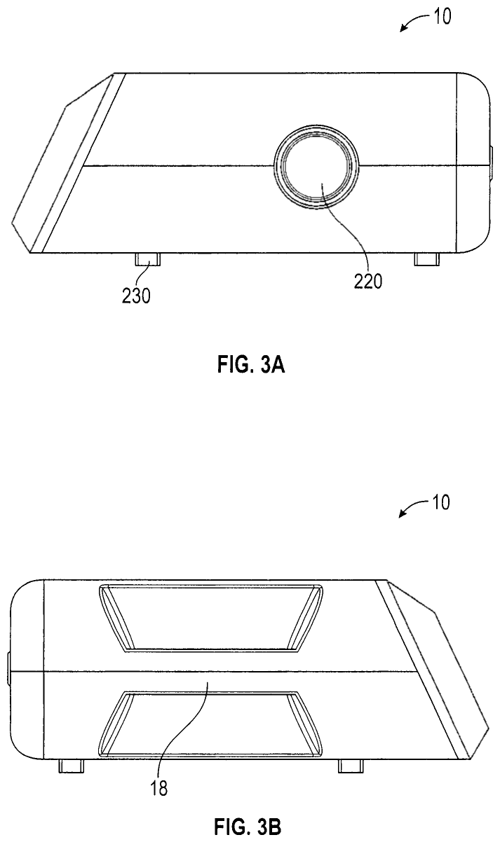

FIG. 3a illustrates a side view of the hose side of the pulsator. FIG. 3b illustrates a side view of the handle side of the pulsator.

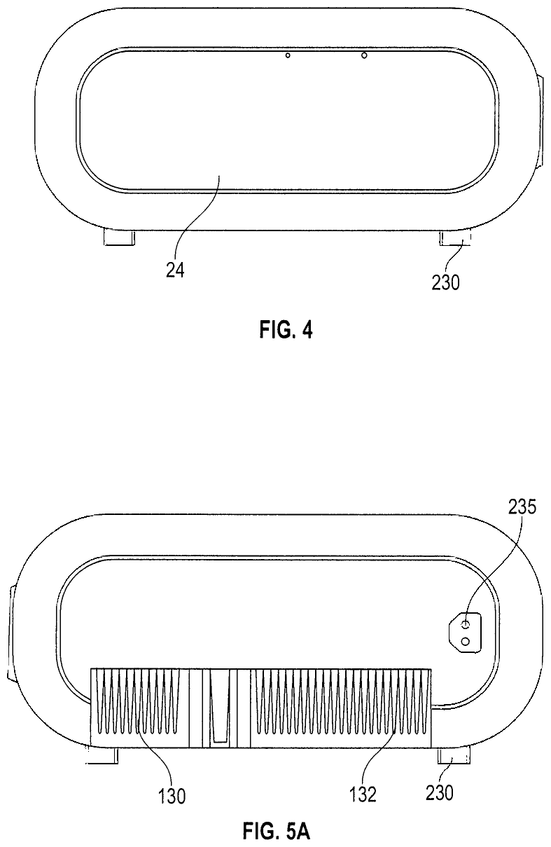

FIG. 4 illustrates a front view of the pulsator. As shown, the pulsator includes a display and control panel 24. The pulsator may further include an ambient light sensor and a power indicator light. The ambient light sensor can adjust brightness of the screen of the control panel 24 based on ambient light in a room in which the pulsator is being used. The power indicator light can be illuminated at all times when the pulsator is plugged in.

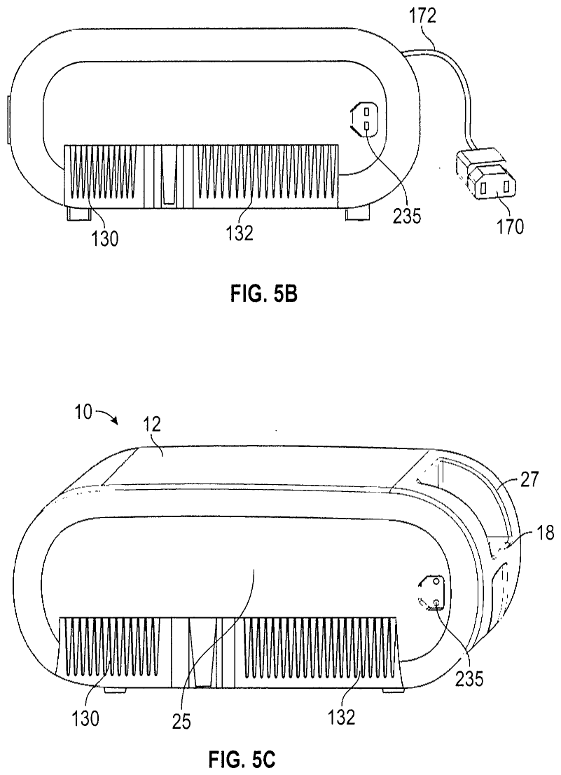

FIGS. 5a-5c illustrate back perspective views of the pulsator. FIG. 5b illustrates a power cord associated with the pulsator. FIG. 5c illustrates the handle 18 on the side wall 27 the pulsator. As shown, the pulsator may include cooling air vents, a power cord connection 235, and a power cord 170. The cooling air vents may include an inlet vent 130 and an outlet vent 132. In the embodiment shown, no filters are provided at the inlet vent or the outlet vent. In other embodiments, a filter may be provided at one or both of the cooling air vents. A power cord connection 235 may be provided at any suitable location on the pulsator and comprises a universal connector and can receive a cord from any country.

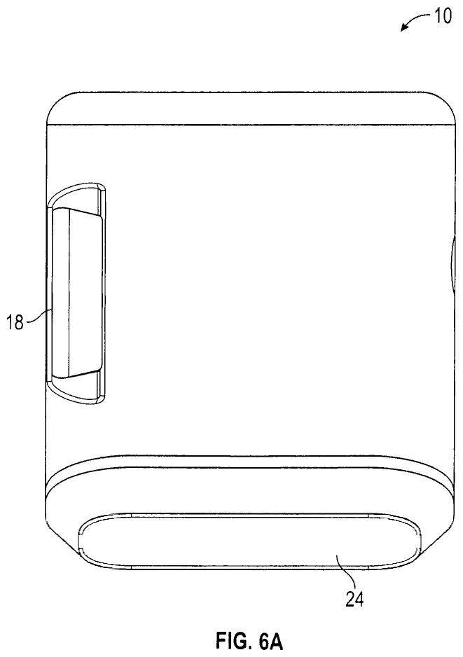

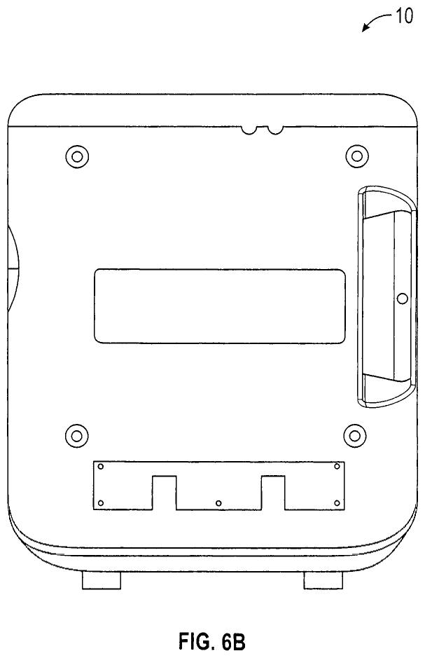

FIG. 6a illustrates a top view of the pulsator 10. FIG. 6b illustrates a bottom view of the pulsator 10.

Returning to FIG. 4, a control panel is provided for controlling the air pulse generator. In the embodiment shown, the control panel is integral to a display and comprises a touchscreen 24. The terms control panel and touchscreen may be used interchangeably herein and are generally used to reference a user interface with which a user may control the pulsator. The touchscreen provides interactive controls for programming time, frequency, and pressure of air directed to the therapy garment during therapy. The touchscreen may be a capacitive sensor touchscreen. Any suitable control devices, including switches, dials, audible instructions picked up by a microphone, and others, can alternatively be used to program time, frequency and pressure of air transmitted to therapy garment. With specific reference to FIG. 2a, the screen 24 is readily accessible by the respiratory therapists and user of the pulsator. In the embodiment shown, the touchscreen 24 is mounted on a front wall 13. However, the touchscreen may be provided in any other suitable location.

The control panel 24 provides a user interface to the user. The user interface may be a graphical user interface that is easy to use, facilitates user programming of therapies and control during therapies, can display new features added during an update, and can display help screens as needed. In some embodiments, flashing buttons may be provided. The user interface is customizable and may be personalized. The user interface may include buttons that may be customized in size and customized with labels. The control panel may be updated via downloading of update instructions. Sliding levers may be provided for controlling various aspects of therapy.

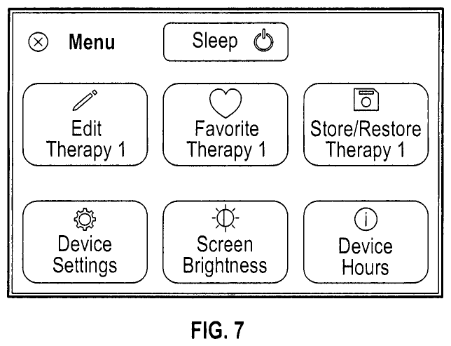

FIG. 7 illustrates a menu screen of the user interface, in accordance with one embodiment. The menu allows activation of sleep mode, editing of a therapy, favoriting of a therapy, storing/restoring of a therapy, changing brightness of the screen, checking device hours, and viewing device settings. In other embodiments, further capabilities may be provided at the menu screen. Each of these may be done by pressing the respective button. Selecting the Check Device Hours button will display how many hours the device has been used and may display a customer service phone number. Sleep mode may be used to dim the touchscreen and save power. The pulsator may be configured to automatically go into sleep mode after a period of inactivity or can be manually set to sleep mode via the menu screen. Selecting the Device Settings button may access Bluetooth settings, device version, lock device, and diagnostics.

The control panel 24 may have a variety of default screens. Example default screens may include a Home Use Screen, a Hospital Use Screen, and an International Use Screen.

The user interface allows a user to program therapies. In one embodiment a user can program up to three therapies. The user can program a number of segments per therapy and a therapy duration. For example, a user could program six segments for a therapy having a duration of 60 minutes and the default algorithm would set each therapy for 10 minutes. The user can further program in cough breaks. The cough breaks do not count against the therapy duration. For example, if the user programs 3 cough breaks of two minutes each in a therapy having a duration of 60 minutes, the total time for receiving the therapy would be 66 minutes. Programmed therapies can be stored and may restored from backup. Details of therapy programming are provided below.

In some embodiments, three types of therapies may be programmed. These include Program Mode, Ramp Mode, and Manual Mode. Each of these therapies may be customized for a specific user. Program Mode sets and saves a plurality of cycles (for example, up to six), that can each have their own duration, frequency, and pressure per cycle. When a Program Mode therapy is run, the pulsator will transition through each cycle sequentially until all are complete. Ramp Mode sets a minimum and a maximum frequency and pressure wherein the pulsator will ramp up and down between the minimum and maximum settings for the set time interval. Manual Mode can be used to start a therapy at default settings, and adjust frequency, pressure, and therapy time while the therapy is being delivered, based on what is most effective and/or comfortable for the user.

In some embodiments, a user may be given the option of creating a therapy based on how they are feeling. A Good Day therapy may be programmed for days when a user is feeling well. The Good Day therapy may be a maintenance, routine therapy. A Bad Day therapy may be programmed for days with a user is feeling more congested. A Bad Day therapy may be a more robust therapy. It is to be appreciated that reference to a user creating a therapy may refer to a medical professional, a patient, or other as a suitable person.

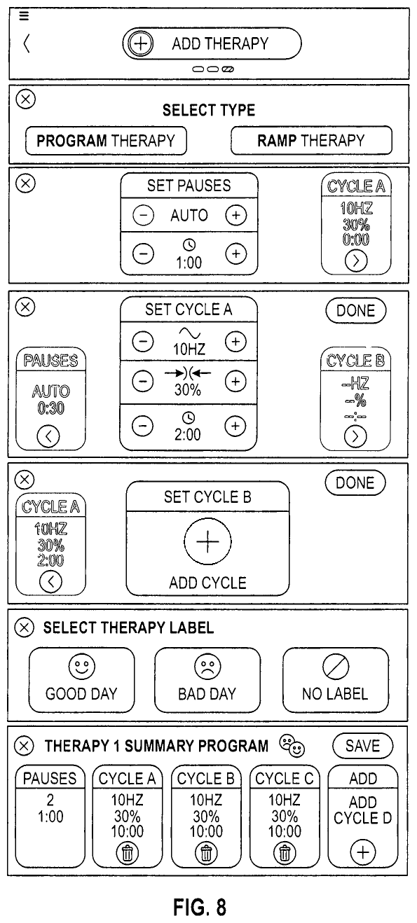

FIG. 8 illustrates a series of user interface screens displayed on the touchscreen for setting a therapy. From a home screen, the user presses an “Add Therapy” button. The user then selects what type of therapy—Program Therapy or Ramp Therapy. FIG. 8 illustrates adding a Program Therapy.

Upon selecting to add a Program therapy, the user is prompted to Set Pauses. The treatment protocol will pause or hold for a cough break at the end of an interval. This is time designated to clear secretions. The user can adjust pause settings including number of pauses and durations of pauses. The user can select the number and duration by pressing up and down buttons or can select Auto. The default pause duration is 1 minute and can be adjusted from 00:15 to 5:00 minutes in increments of 15 seconds.

After setting pauses, the user is prompted to Set Cycle A. This entails adjusting cycle settings including frequency, pressure, and time. Each of these may be adjusted by pressing up and down buttons. In one embodiment, frequency is adjusted in 1 Hz increments from 5 to 20 Hz, pressure is adjusted in 5% increments from 10% to 100%, and time is adjusted in 1-minute increments from 1 to 60 minutes. If only one cycle is desired, the user presses the done button. If further cycles are desired, the user presses the next button and is prompted to Set Cycle B. When all desired cycles are set, the user presses the done button.

After the therapy settings are selected, the user may be given the option of applying a therapy label—Good Day, Bad Day, or No Label. The User then reviews the Therapy Summary Page. From the Therapy Summary Page, the user can edit the therapy. Once the user confirms the therapy, the user can save the Program Therapy.

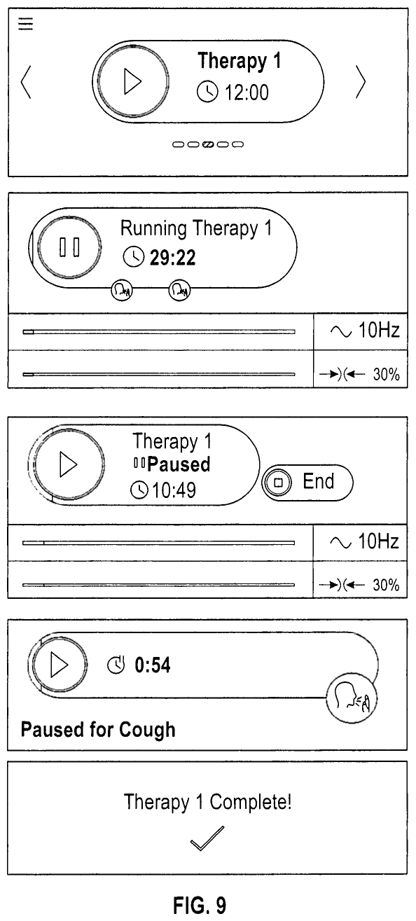

FIG. 9 illustrates a series of user interface screens displayed on the touchscreen for starting a Program Therapy. From the home screen, the User selects the desired Program Therapy and presses the play button to begin treatment.

A Running Selected Therapy (here Running Therapy 1) screen will be displayed. The therapy run time bar fills as time passes. When the blue bar is completely full, therapy is completed. The Running Selected Therapy screen shows when a pause (or cough break) will occur during treatment. The screen further displays the current frequency and the current pressure during treatment. The user can manually pause treatment by pressing a pause button and can resume treatment by pressing the play button. Alternatively, the user may press the end button from a pause to end therapy.

When a pause is reached, the pulsator will stop generating air pulses. The pulsator may give an audible prompt to cough—such as beeping. A pause run time bar will fill as time passes. When the pause run time bar is full (and the timer reaches 00:00), the user may press the play button to resume therapy. In some embodiments, therapy may automatically resume when the timer reaches 00:00. Therapy cycles and pauses are continued until the treatment program is complete and a completed screen appears.

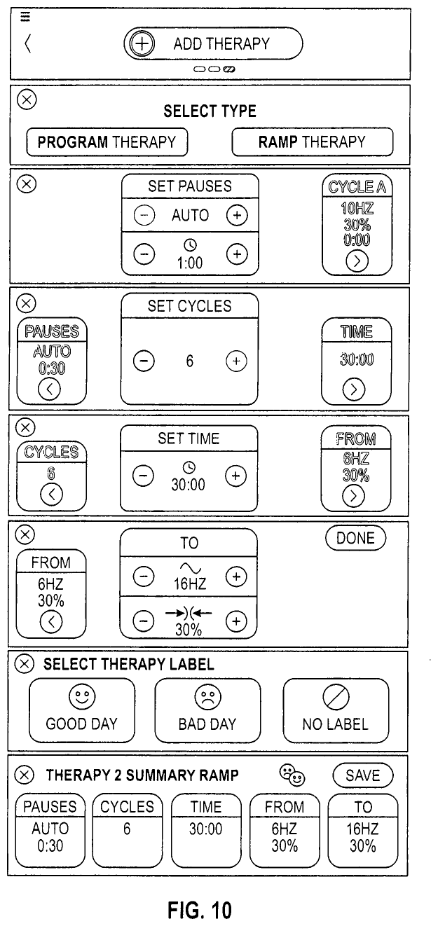

FIG. 10 illustrates a series of user interface screens displayed on the touchscreen for setting a therapy. From a home screen, the user presses an “Add Therapy” button. The user then selects what type of therapy—Program Therapy or Ramp Therapy. FIG. 10 illustrates adding a Ramp Therapy.

Upon selecting to add a Ramp therapy, the user is prompted to Set Pauses. The treatment protocol will pause or hold for a cough break at the end of an interval. This is time designated to clear secretions. The user can adjust pause settings including number of pauses and durations of pauses. The user can select the number and duration by pressing up and down buttons or can select Auto. The default pause duration is 1 minute and can be adjusted from 00:15 to 5:00 minutes in increments of 15 seconds.

After setting pauses, the user is prompted to Set Cycles. This entails setting the number of cycles by pressing the up and down buttons. In some embodiments, the user can select up to six cycles. The user is prompted to Set Time, or duration of therapy. This can be adjusted in 1-minute increments from 1 minute to 60 minutes.

After setting pauses and duration, the user is prompted to set frequency and pressure settings. Each of these may be adjusted by pressing up and down buttons. In one embodiment, frequency is adjusted in 1 Hz increments from 5 to 20 Hz and pressure is adjusted in 5% increments from 10% to 100%. When the settings are complete, the user presses the done button.

After the therapy settings are selected, the user may be given the option of applying a therapy label—Good Day, Bad Day, or No Label. The User then reviews the Therapy Summary Page. From the Therapy Summery Page, the user can edit the therapy. Once the user confirms the therapy, the user can save the Ramp Therapy.

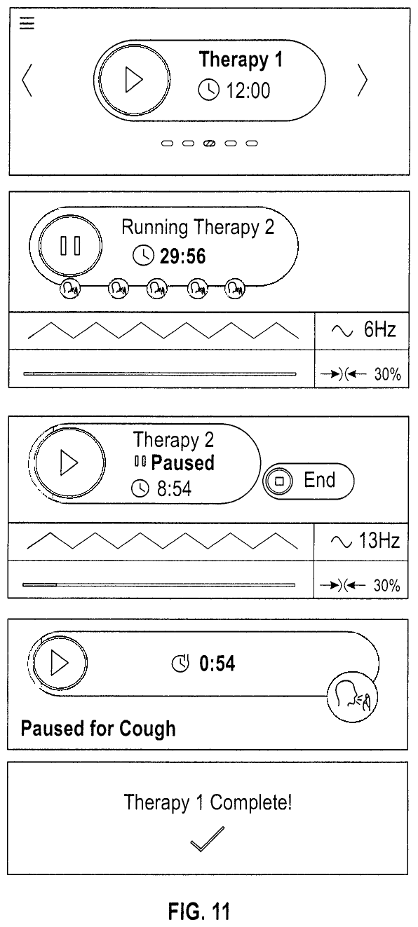

FIG. 11 illustrates a series of user interface screens displayed on the touchscreen for starting a Ramp Therapy. From the home screen, the User selects the desired Ramp Therapy and presses the play button to begin treatment.

A Running Selected Therapy (here Running Therapy 2) screen will be displayed. A therapy run time bar fills as time passes. When the bar is completely full, therapy is completed. The Running Selected Therapy screen shows when a pause (or cough break) will occur during treatment. The screen further displays the current frequency and the current pressure during treatment. The user can manually pause treatment by pressing a pause button and can resume it by pressing the play button. Alternatively, the user may press the end button from pause to end therapy.

When a pause is reached, the pulsator will stop generating air pulses. The pulsator may give an audible prompt to cough—such as beeping. A pause run time bar will fill as time passes. When the pause run time bar is full (and the timer reaches 00:00), the user may press the play button to resume therapy. In some embodiments, therapy may automatically resume when the timer reaches 00:00. Therapy cycles and pauses are continued until the treatment program is complete and a completed screen appears.

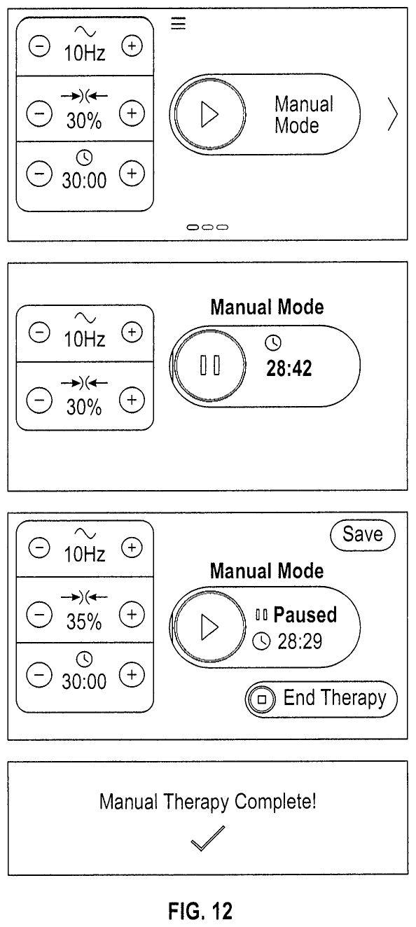

FIG. 12 illustrates a series of user interface screens displayed on the touchscreen for Manual Mode. Manual Mode allows the user to quickly start therapy at default settings, then adjust frequency, pressure, and therapy time (or duration) while therapy is being delivered.

From the home screen, the User selects Manual Mode. The User then adjusts the therapy settings including frequency, pressure, and time. Each of these may be adjusted by pressing up and down buttons. In one embodiment, frequency is adjusted in 1 Hz increments from 5 to 20 Hz, pressure is adjusted in 5% increments from 10% to 100%, and time is adjusted in 30 second increments from 30 seconds to 60 minutes. After the settings are selected, the user presses play to start treatment.

Frequency and pressure can be changed at any time during Manual Mode by pressing the up and down buttons. In some embodiments, time or duration can only be adjusted when the pulsator is not generating pulses. The user can press pause to pause the therapy and to change the duration of the therapy. The user can press play to resume therapy after a pause. The user may press End Therapy to end therapy.

If the user changes frequency or pressure settings during therapy, the user can press save to save the new settings as their Manual Mode settings. When treatment is complete a completed screen appears.

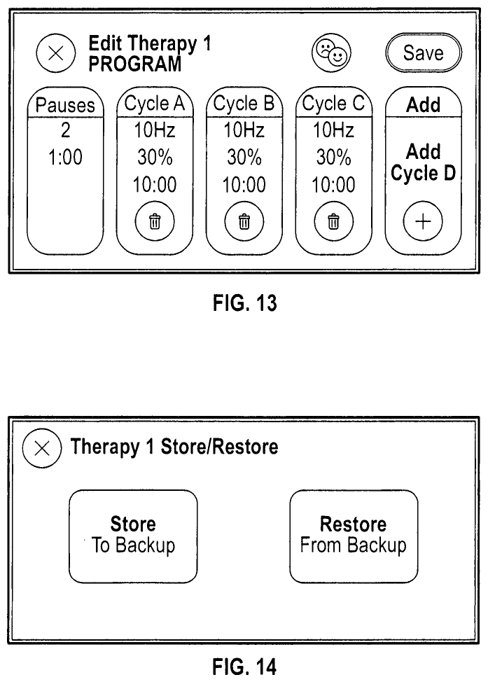

FIG. 13 illustrates a user interface screen displayed on the touchscreen for editing a therapy. After selection of editing a selected therapy from the menu screen of FIG. 7, an Edit Selected Therapy (here Therapy 1) screen is displayed. The user can press the label icon to change or add a therapy label. The user can press Pauses or any Cycle to edit the corresponding pauses or cycle.

FIG. 14 illustrates a user interface screen for storing a therapy to back up and restoring a therapy from back up. After selection of storing/restoring a selected therapy from the menu screen of FIG. 7, a Selected Therapy (here Therapy 1) Store/Restore screen is displayed. The user can press the Store or Restore button respectively.

Storing the therapy to back up performs a backup of the therapy that can later be restored. In some embodiments, the pulsator will automatically store the settings of a therapy to backup after it has been performed 30 times. New therapies may be automatically stored to backup when the therapy is created. Restoring a therapy from backup may be useful if changes have been made to the therapy and it is necessary to start from the original therapy than from scratch.

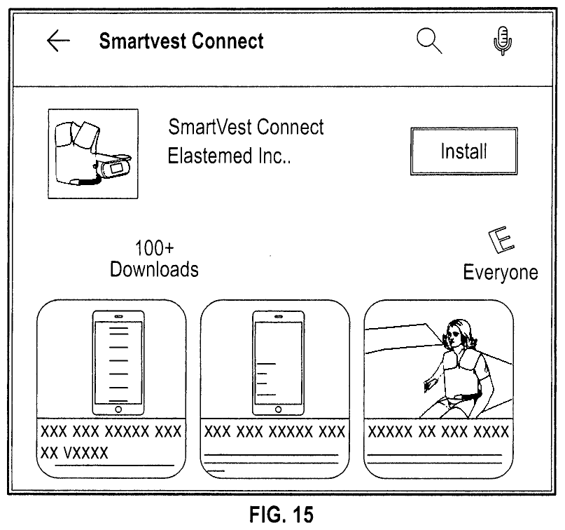

FIG. 15 illustrates a diagram of an HFCWO system including an associated mobile app. In such system, the pulsator may have wireless connectivity wherein the pulsator may communicate to an app, such as a mobile app, for local storage and subsequent transfer to a server. In some embodiments, device data may be stored locally on memory in the pulsator and be directly uploaded to a server. It is to be appreciated that other manners of communicating pulsator data from the pulsator to a server may be used.

Connectivity of the HFCWO system provides a number of capabilities. While Bluetooth connection is specifically referred to, other types of network connections may be used and reference to Bluetooth connection is intended to cover all such connections, now existing or later developed. Using a Bluetooth connection, the pulsator communicates device data, including usage data and errors, to a connected device, such as a mobile device, which then can upload the data to storage, such as cloud storage. Alternatively, the pulsator may communicate device data directly to a server. The device data may be used to look at compliance and fault codes, and to troubleshoot the pulsator. Compliance data may comprise how often the HFCWO system is being used and what therapy is being administered. The system may further store whether the user is having a good day, a bad day, or an average day based on the therapy administered.

In some embodiments, the Bluetooth connection may provide remote control of the pulsator. This may include remote control for the user—for example, start, stop, pause, and status of therapy. It may further include remote control for a medical professional to input new settings, prescriptions, instructions and the like. In such embodiments, the mobile app is provided with a remote control interface. The remote control interface may be different depending on the type of user of the mobile app. The Bluetooth connection can further be used to remind the user to use the HFCWO system.

In some embodiments, the HFCWO system may use the mobile app to coordinate with other devices to provide comprehensive care. Such coordination may be useful for health monitoring, communicating instructions, communicating reminders for taking medication, illustrating trends in vital signs and notifying changes to the trends, and the like. Device data from the HFCWO system, combined with body temperature, pulse rate, respiratory rate, blood pressure, blood oxygen levels and/or other vital signs may be coordinated to provide a comprehensive view of user health and assist a user in avoiding exacerbations and visits to the hospital. In some embodiments, the HFCWO system, via the mobile app, a web app, or other the mobile app may coordinate with another device to gather health information about a user of the high frequency chest wall oscillation system, wherein the other device measures at least one vital sign. Such health information, from the HFCWO system or from the other device, may be stored on a server for a health professional to access.

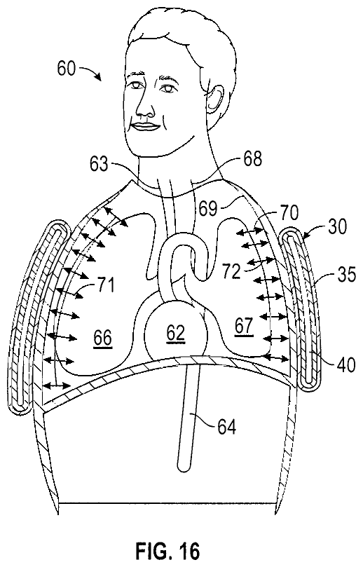

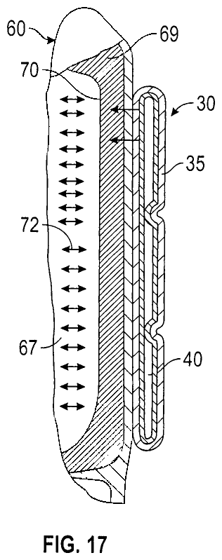

Details of the physical components of the HFCWO system will now be given. FIG. 16 illustrates a thoracic therapy garment located around the thorax of a person. FIG. 17 is an enlarged sectional view of the right side of the thoracic therapy garment of FIG. 16 on the thorax of a person. The thoracic therapy garment 30, may be worn around a user's thorax 69 in substantial surface contact with the circumference of thorax 69. The garment 30 includes an air core 35 having one or more enclosed chambers 40 for accommodating air pulses and air under pressure. The pressure of the air in the chambers retains the garment 30 in firm contact with the thorax 69. The air core 35 may have a plurality of holes that vent air from the chambers 40. The thoracic therapy garment 30 functions to apply repeated high frequency compression or pressure pulses, shown by arrows 71 and 72, to the person's lungs 66 and 67 and trachea 68. The reaction of the lungs 66 and 67 and trachea 68 to the pressure pulses causes repetitive expansion and contraction of the lung tissue resulting in secretions and mucus clearance therapy. The thoracic cavity occupies only the upper part of the thoracic cage which contains the lungs 66 and 67, heart 62, arteries 63 and 64, and rib cage 70. The high frequency pressure pulses applied to the thorax 69 stimulates the heart 62 and blood flow in the arteries 63 and 64 and veins in the chest cavity. The rib cage 70 also aids in the distribution of the pressure pulses to the lungs 66 and 67 and trachea 68.

Operation of the pulsator 10 will now be described. It is to be appreciated that aspects of the system disclosed herein may be used with pulsators 10 that operate other than as described so long as the pulsator delivers air pulses having a frequency and a pressure.

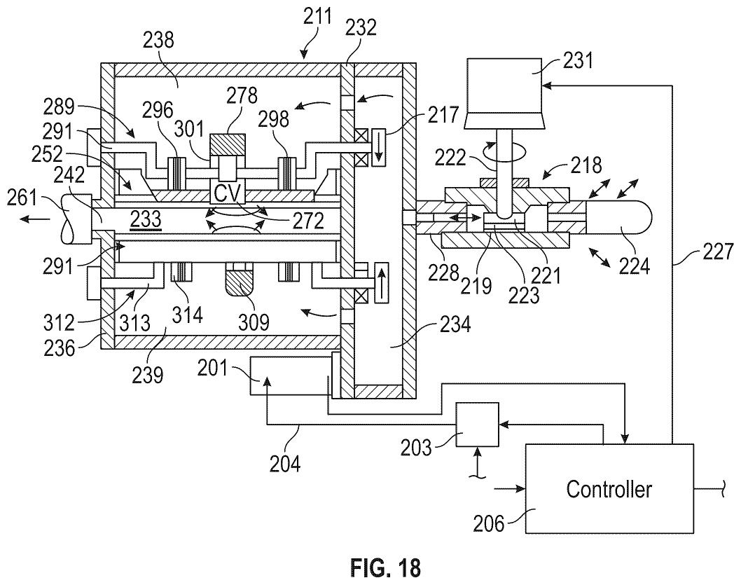

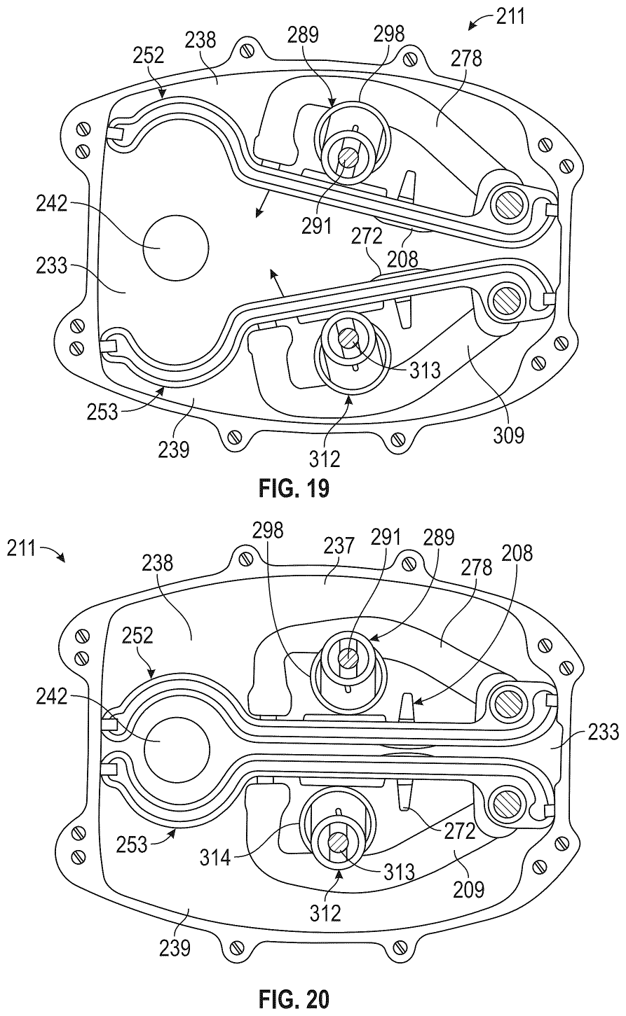

FIG. 18 illustrates a diagram of the programmable control system for an air pulse generator. FIGS. 19 and 20 illustrate views of the air pulse generator in use. The air pulse generator 211 has an internal wall 232 separating an air pulsing chamber 233 from a manifold chamber 234. A pair of displacers 252 and 253 are pivotally mounted on wall 232 and 236 on opposite sides of the pulsing chamber 233. The displacers 252 and 253 are angularly moved to move air through and pulse exit air from the air pulse generator 211. The air pumping chambers 238 and 239 are provided adjacent to the outsides of the first and second displacers 252 and 253. The air pumping chambers are in air communication with the manifold chamber 234. Holes in the wall 232 allow air to flow between the chambers 234, 238 and 239. Check valves 208 and 272 mounted on the displacers 252 and 253 allow air to flow from the air pumping chambers 238 and 239 into the pulsing chamber 233 when the displacers 252 and 253 are moved to their open positions as shown in FIG. 19. Air in the pulsing chamber 233 flows through a passage 242 into a flexible hose 261 connected to therapy garment 30.

The displacers 252 and 253 are angularly moved between open and closed positions using power transmission mechanisms 289 and 312. The power transmission mechanisms 289 and 312 each include crankshafts 291 and 313 supporting roller members 296, 298 and 301. The roller members 296, 298, and 301 are operatively associated with the displacers 252 and 253 and the arms 278 and 309 to angularly move displacers 252 and 253. An electric motor 201 connected to a power transmission assembly 217 rotates crankshafts 291 and 313 of power transmission mechanisms 289 and 312 in opposite rotating directions. Further details of air pulse generator 211 are disclosed in U.S. Pat. No. 10,016,335, incorporated herein by reference.

The air pressure in garment 30 may be regulated with a proportional air flow valve 218 having a variable orifice that restricts the flow of air into and out of the air pulse generator 211. The valve 218 has a body 219 having a passage 221 for accommodating air flow through body 219 from a porous air filter member 224 to the air pulse generator 211. In some embodiments, no filter may be used. The body 219 has a second air bypass passage 223 that allows air to flow through body to the air pulse generator 211. The passage 223 allows for a limited free flow of air to the air pulse generator 211 whereby the air pulse generator 211 has a supply of air so that therapy treatment will not go down to zero. An air flow control member 228 connects the body 219 to the air pulse generator 211. The air flow control member 228 limits the maximum volume of air flow into and out of air pulse generator 211 to limit peak air pressure in the garment 30 to a maximum safe level. An air flow control member or restrictor 222 has an end located in passage 228 for varying the size of passage 221 thereby regulating the flow of air through passage 221. The air flow control member 222 may be, for example, a threaded rod rotated with a control device 231, such as a solenoid or stepper motor, to vary the flow of air through passage 221. The control device 231 is wired with cable 227 to the controller 206, which regulates the operation of the control device 231 thereby adjusting the air flow control member 222 to regulate the flow of air through passage 221.

The control panel/touchscreen described above allows the user to operate the pulsator. Using the touchscreen, the user may control time or duration of operation the motor, frequency of air pulses, and pressure of air pulses. General example parameters are discussed but these are not intended to be limiting. The time may be selected from, for example, 30 seconds to 60 minutes. Air pulse frequency may be between, for example, 5 and 20 Hz or cycles per second. Pressure may be selected from 10% to 100%.

The motor 201 may be wired with a cable 204 to a motor control device 203. The motor control device 203 is operable to regulate the operating speed of the motor 201 as determined by the controller 206, in accordance with the therapy programmed and selected by the user. A cable wires the controller 206 to the motor control device 203. The motor 201 may include a motor speed sensor wired with a cable to controller 206. The motor speed data from the sensor is digital data may be used with a lookup table included in controller 206 to maintain a selected pulse frequency generated by air pulse generator 211 when the speed of motor 201 increases or decreases. The lookup table is an array of digital data of motor speed and air pressure precalculated and stored in static program storage which is initialized by changes in the motor speed to provide an output to the stepper motor 231 to regulate the air flow control member 222 to maintain a preset or selected air pressure created by the air pulse generator 211. In alternative embodiments, a lookup table may not be used and other manners of determining motor speed and air pressure may be used.

FIGS. 19 and 20 illustrate views of the pulse generator 211. In use, the displacers 252 and 253 angularly move between open and closed positions to draw air into the air pumping chambers 238 and 239 and pulse air out of chamber 233. When the displacers 252 and 253 are moved by operation of the crankshafts 291 and 313 from the open positions to the closed positions, air is drawn through the air flow valve 218 into the manifold chamber 234 and air pumping chambers 238 and 239. The check valves 208 and 272 are used to ensure one way airflow between air pumping chambers 238 and 239 and into the pulsing chamber 233. The air in the pulsing chamber 233 is forced out through the passage 242 into the hose 61 coupled to garment 30. When the displacers 252 and 253 are moved from the closed positions, shown in FIG. 19, to the open positions, shown in FIG. 20, air flows through the check valves 208 and 272 from the air pumping chambers 238 and 239 into the pulsing chamber 233. The air flow in the pulsing chamber 233 is rhythmically pulsated. The frequency of the air pulses is regulated by the speed of operation of the motor 201. An increase in the speed of motor 201 increases the frequency of the air pulses generated by the air pulse generator 211. Conversely, a decrease in the speed of the motor 201 decreases the frequency of the air pulses generated by the air pulse generator 211.

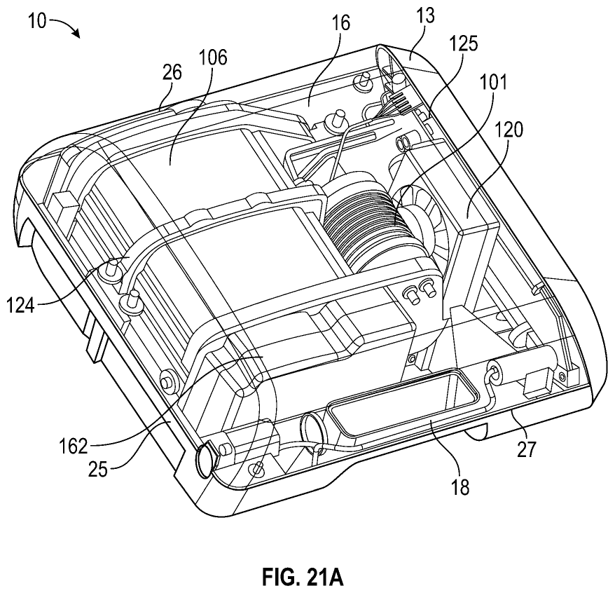

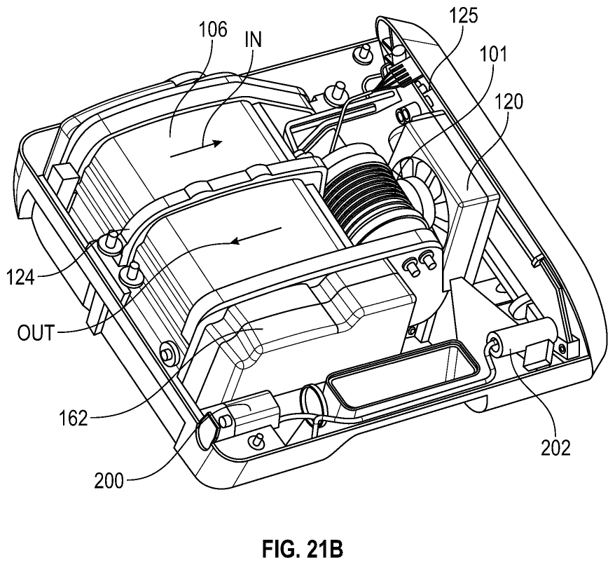

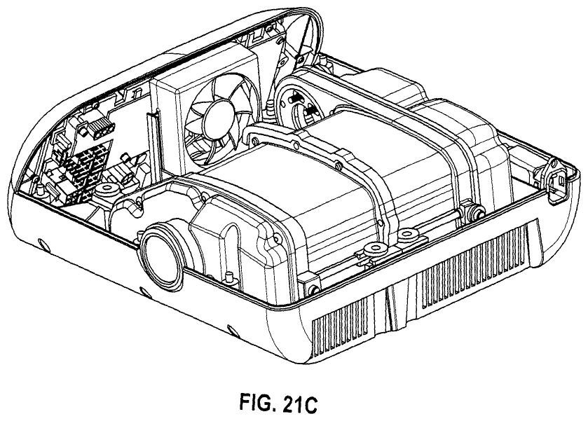

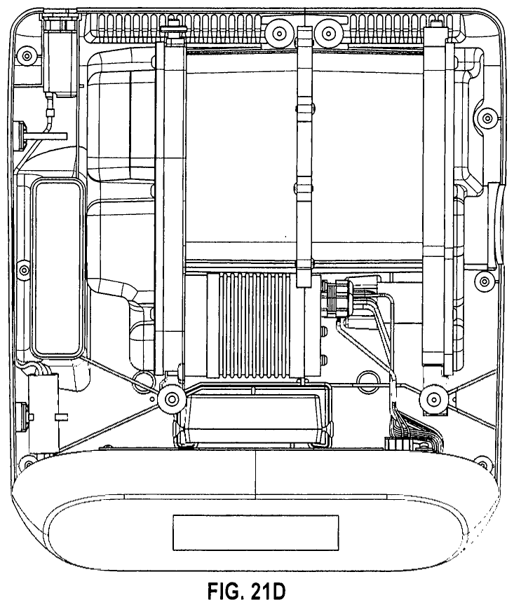

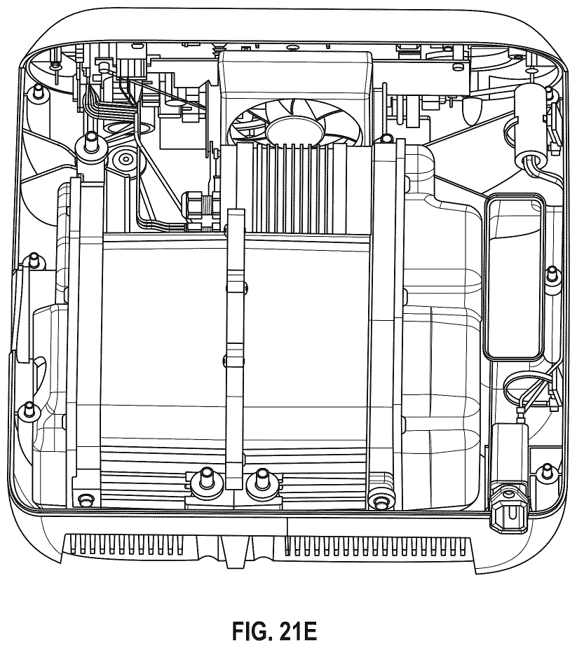

FIGS. 21a-21e illustrate internal views of a portable pulsator, in accordance with one embodiment. This embodiment has enhanced airflow and cooling capabilities. A filter may be omitted from this design (though may be used if desired). The pulsator includes a motor, a pump driven by the motor, and one or more fans. FIG. 21a illustrates a perspective view of the pulsator with the top wall of the housing shown transparent to allow view into an interior of the pulsator. FIG. 21b illustrates the pulsator with the top wall of the housing removed. FIG. 21c illustrates an alternate perspective view of the pulsator with the top wall of the housing removed. FIG. 21d illustrates a top view of the pulsator with the top wall removed. FIG. 21e illustrates a top perspective view of the pulsator with the top wall removed.

As shown, the pulsator 10 includes a case 100 located within the housing 12. The case 100 holds an air pulse generator 11, also referred to as a pump. A circuit board 122 is provided for supporting electronic components, including for driving the user interface of the touchscreen. The motor 101 drives the air pulse generator 11 in a manner to control the time duration and frequency of the air pulses produced by generator 11 and directed to the garment 30.

FIG. 21b illustrates a casing 162 for a belt assembly. The belt assembly includes a belt drive and is a connection between the motor and the drive. The belt drive comprises a timing belt that times the crank shafts on both sides of the pistons to reduce speed and time the pump. FIG. 21b further illustrates a power inlet module 200 through which power is directed to a wire and to a ferrite module 202 for reducing electromagnetic emissions.

Airflow channel gasketing is provided over a case housing the pump. An airflow pathway is defined by the airflow channel gasketing. Air flows through an air inlet, along the airflow channel gasketing, over the motor, along the other side of the airflow channel gasketing, and out an air outlet. An in airflow channel and an out airflow channel are defined by the airflow channel gasketing. The airflow channels have interior ends in the housing proximate the front wall. A circuit board is provided at the interior end of the in airflow channel. A fan is provided at the interior end of the out airflow channel. A motor is provided between the fan and the case housing the pump along the out airflow channel.

The pulsator 10 includes a fan 120, proximate the motor 101 and the circuit board 122. The fan 120 is provided at an interior end of the out airflow channel. Each of the fan 120 and the airflow channel gasketing 124 assists with airflow and cooling within the housing 12 and over the circuit board 122. A challenge with pulsators such as shown is regulating heat within the pulsator housing 12. Electronics, the motor 101, and pump 11 are provided in the housing 12 and it is generally desirable for the housing 12 to have a small configuration to enhance portability while maintaining an acceptable level of heat within the housing. The airflow channel gasketing 124 and fan 120 create an airflow pathway enhancing cooling within the housing 12. In one embodiment, the airflow channel gasketing 124 is formed of neoprene closed cell foam and goes around a circumference of the case 100 substantially completely.

An in airflow channel pathway is shown with the arrow marked IN. An out airflow channel pathway is shown with the arrow marked OUT. The airflow channel gasketing 124 separates the in airflow channel and the out airflow channel over the case 100. The circuit board 122 is provided at an interior end of the in airflow channel. A fan 120 and motor 101 are provided generally beside the circuit board and at an interior end of the out airflow channel. Air flows into the housing 12 through an inlet vent 130 (shown in FIG. 5a) over the case 100 on one side of the airflow channel gasketing 124 along the in airflow channel. The air reaches the circuit board 122, cooling elements thereon, and is directed by the fan 120 over the motor 101 and along the out airflow channel and out the outlet vent 132 (shown in FIG. 5a). The fan 120 pushes air over the motor at a high airflow and cools the motor.

In general, air flows into the housing 12 through the inlet vent 130, is directed by the airflow channel gasketing 124 along one side of the case 100, approaches the motor 101, and is directed by the fan 120 over the motor 101, back over the case 100, and out of the outlet vent 132. The resultant airflow cools the motor about 10° C.

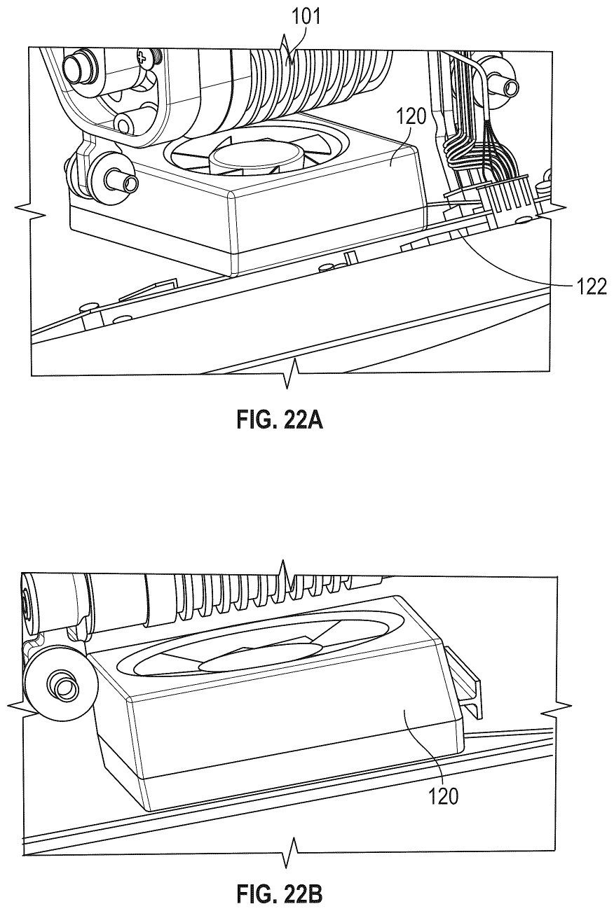

FIGS. 22a and 22b illustrate views of the fan 120 of the pulsator. As shown, the fan 120 may be positioned offset from the circuit board 122 and in front of the motor 101. The fan 120 is provided at an interior end of the out airflow channel or pathway relatively near the front wall 13 of the outer casing of the housing 12. In the embodiment shown, the fan 120 is provided within a fan housing 140. In one embodiment, the fan housing 140 is an elastomer boot, functioning to reduce noise made by the fan even when the pulsator is idle. The fan housing 140 may completely encase the fan.

The fan may be a directional high airflow fan and can pump air at, for example, 44 cfm. The fan is provided at an interior end of the out airflow pathway and in front of the motor 101. The fan operates to blow air over the motor 101 towards the outlet vent 132. The fan is offset from the in airflow pathway and does not interfere with air coming in.

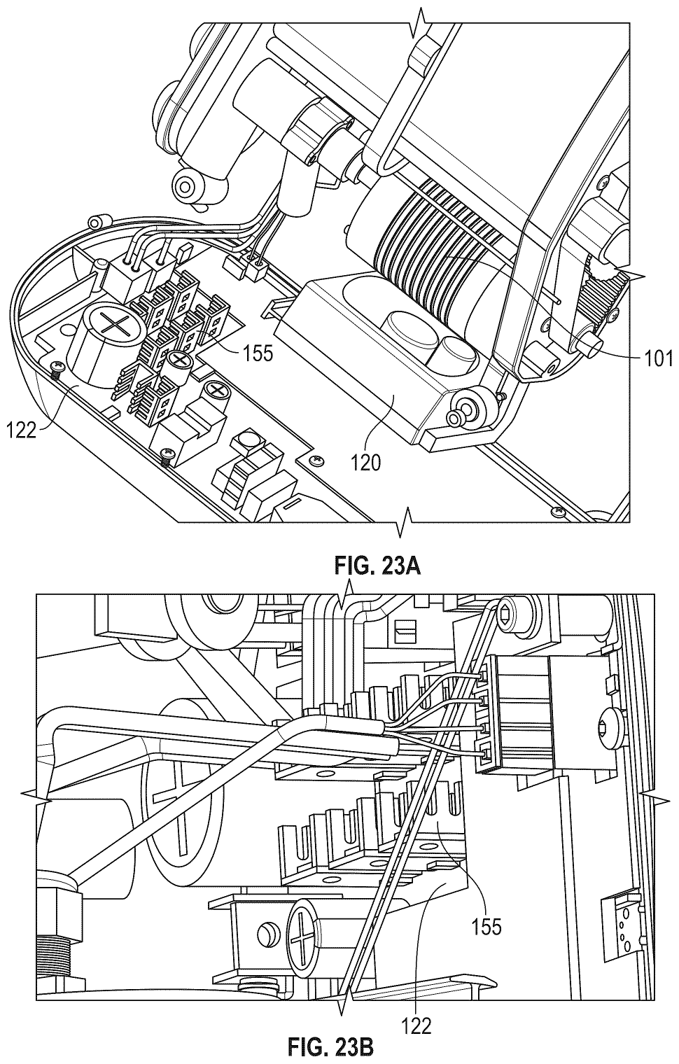

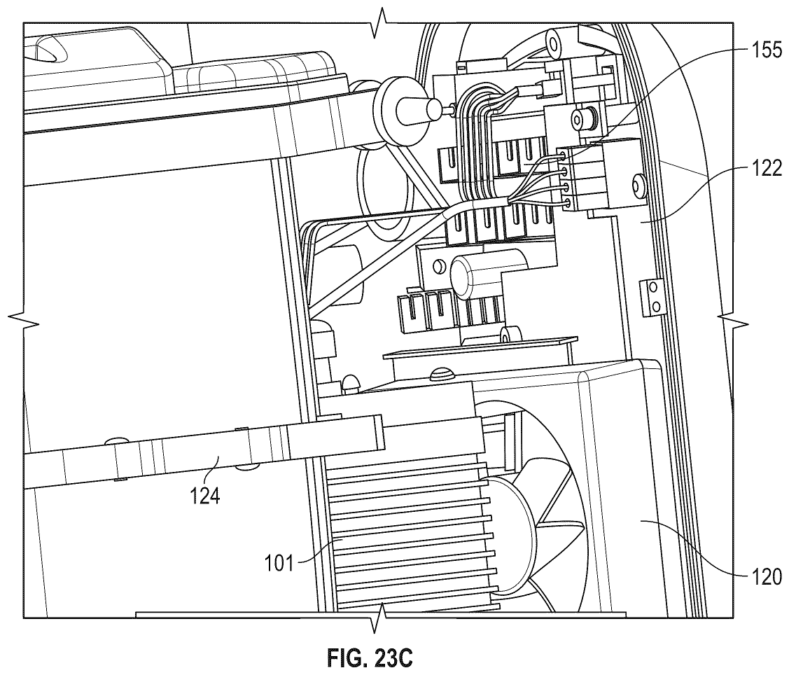

FIGS. 23a-23c illustrates the circuit board 122. The circuit board 122 may be provided at an interior end of the in airflow pathway. FIG. 23a illustrates the front wall 13 of the housing 12 with the circuit board 122 provided along a back surface thereof. FIG. 23b illustrates a close up of the circuit board 122 and heat sinks 155. FIG. 23c illustrates the relative orientation of the circuit board 155, heat sinks 155, motor 101, and fan 120.

The circuit board includes capacitors for powering the board and a wire connector. The wire connector may comprise a stepper valve connector and receives wires to connect to the stepper motor that controls the pressure of the garment worn by a user. Components on the circuit board 122 generate heat during use. To facilitate reducing heat in the pulsator 10, heat producing components 150 of the circuit board 122 are grouped in a heat sink area 156 and a plurality of heat sinks 155 are provided. Air is directed over this area by the airflow channel gasketing 124.

The circuit board drives the user interface, the display, the motor, and the stepper motor. The circuit board has Bluetooth capability and a universal power supply. The Bluetooth capability allows the device to connect to a mobile app that a user of the pulsator may have on a personal device. The pulsator thus may report data such as when it is run, what settings it is run at, and how long it is run.

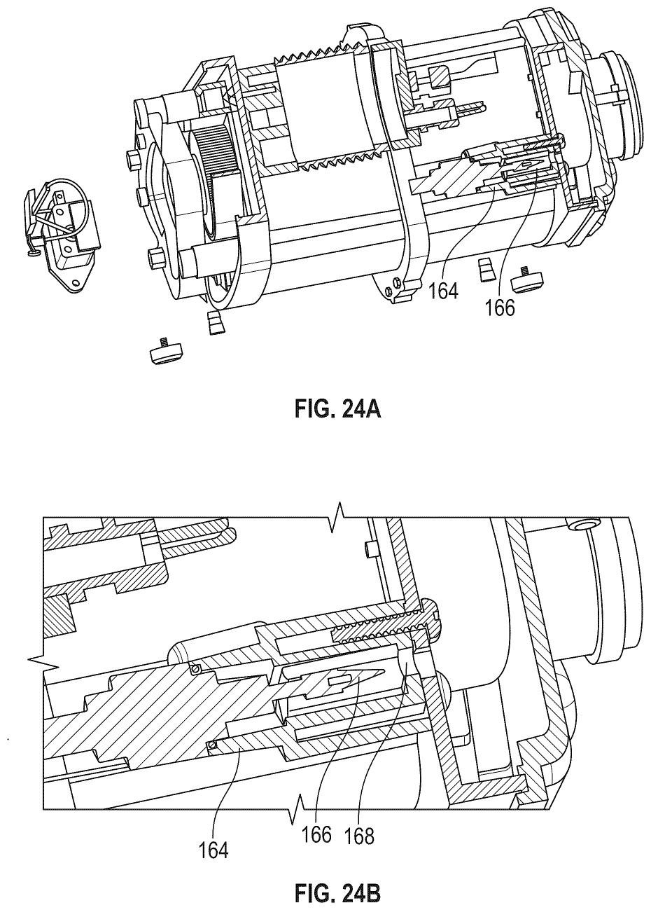

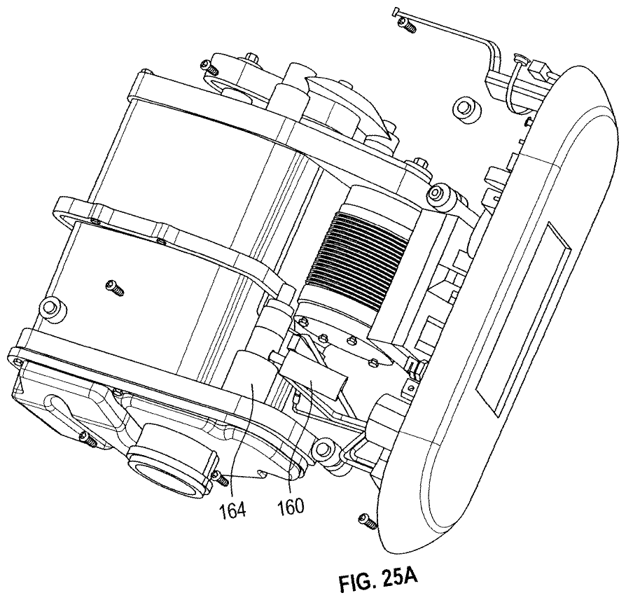

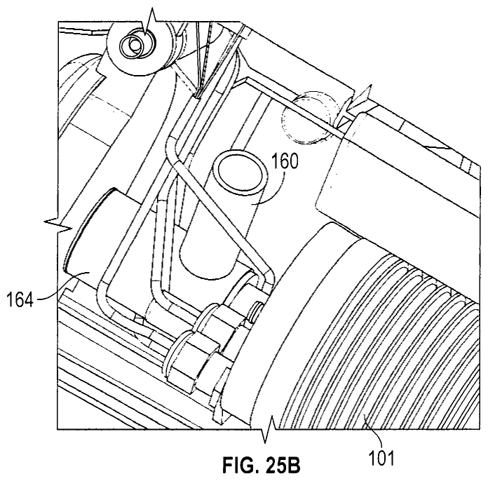

In some embodiments, the pulsator is provided with noise dampening elements. FIGS. 24a and 24b illustrate a stepper valve or stepper motor assembly 164 having needle valve 166. FIGS. 25a and 25b illustrate a dampening tube 160 that may be provided with the stepper valve assembly 164. The stepper valve rotates and moves the needle forward and backward. At a fully forward position, the needle valve 166 is within orifice 168, at the home or closed position. Air entering the stepper valve assembly 164 is directed through the orifice or inlet 168, which is small and may result in a high-pitched noise. The dampening tube may be a flexible tube comprising an elastomer. The dampening tube 160 acts like a flow through muffler and absorbs noise going in and out. The dampening tube thus functions to reduce the high-pitched noise produced by air entering the stepper valve assembly 164 through the orifice or inlet 168.

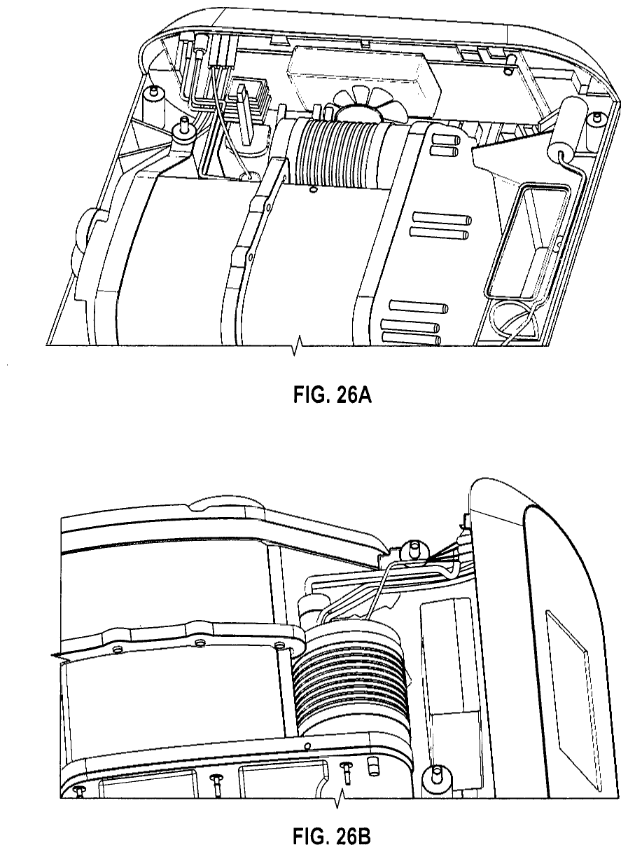

FIGS. 26a and 26b illustrate alternative views of components provided within the housing 12.

As previously discussed, aspects of the invention may be used with alternative pulsators. One such pulsator is disclosed in U.S. Pat. No. 7,537,575, herein incorporated by reference in its entirety.

For purposes of this disclosure, any system described herein may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, a system or any portion thereof may be a minicomputer, mainframe computer, personal computer (e.g., desktop or laptop), tablet computer, embedded computer, mobile device (e.g., personal digital assistant (PDA) or smart phone) or other hand-held computing device, server (e.g., blade server or rack server), a network storage device, or any other suitable device or combination of devices and may vary in size, shape, performance, functionality, and price. A system may include volatile memory (e.g., random access memory (RAM)), one or more processing resources such as a central processing unit (CPU) or hardware or software control logic, ROM, and/or other types of nonvolatile memory (e.g., EPROM, EEPROM, etc.). A basic input/output system (BIOS) can be stored in the non-volatile memory (e.g., ROM), and may include basic routines facilitating communication of data and signals between components within the system. The volatile memory may additionally include a high-speed RAM, such as static RAM for caching data.

Additional components of a system may include one or more disk drives or one or more mass storage devices, one or more network ports for communicating with external devices as well as various input and output (I/O) devices, such as digital and analog general purpose I/O, a keyboard, a mouse, touchscreen and/or a video display. Mass storage devices may include, but are not limited to, a hard disk drive, floppy disk drive, CD-ROM drive, smart drive, flash drive, or other types of non-volatile data storage, a plurality of storage devices, a storage subsystem, or any combination of storage devices. A storage interface may be provided for interfacing with mass storage devices, for example, a storage subsystem. The storage interface may include any suitable interface technology, such as EIDE, ATA, SATA, and IEEE 1394. A system may include what is referred to as a user interface for interacting with the system, which may generally include a display, mouse or other cursor control device, keyboard, button, touchpad, touchscreen, stylus, remote control (such as an infrared remote control), microphone, camera, video recorder, gesture systems (e.g., eye movement, head movement, etc.), speaker, LED, light, joystick, game pad, switch, buzzer, bell, and/or other user input/output device for communicating with one or more users or for entering information into the system. These and other devices for interacting with the system may be connected to the system through I/O device interface(s) via a system bus, but can be connected by other interfaces such as a parallel port, IEEE 1394 serial port, a game port, a USB port, an IR interface, etc. Output devices may include any type of device for presenting information to a user, including but not limited to, a computer monitor, flat-screen display, or other visual display, a printer, and/or speakers or any other device for providing information in audio form, such as a telephone, a plurality of output devices, or any combination of output devices.

A system may also include one or more buses operable to transmit communications between the various hardware components. A system bus may be any of several types of bus structure that can further interconnect, for example, to a memory bus (with or without a memory controller) and/or a peripheral bus (e.g., PCI, PCIe, AGP, LPC, I2C, SPI, USB, etc.) using any of a variety of commercially available bus architectures.

One or more programs or applications, such as a web browser and/or other executable applications, may be stored in one or more of the system data storage devices. Generally, programs may include routines, methods, data structures, other software components, etc., that perform particular tasks or implement particular abstract data types. Programs or applications may be loaded in part or in whole into a main memory or processor during execution by the processor. One or more processors may execute applications or programs to run systems or methods of the present disclosure, or portions thereof, stored as executable programs or program code in the memory, or received from the Internet or other network. Any commercial or freeware web browser or other application capable of retrieving content from a network and displaying pages or screens may be used. In some embodiments, a customized application may be used to access, display, and update information. A user may interact with the system, programs, and data stored thereon or accessible thereto using any one or more of the input and output devices described above.

A system of the present disclosure can operate in a networked environment using logical connections via a wired and/or wireless communications subsystem to one or more networks and/or other computers. Other computers can include, but are not limited to, workstations, servers, routers, personal computers, microprocessor-based entertainment appliances, peer devices, or other common network nodes, and may generally include many or all of the elements described above. Logical connections may include wired and/or wireless connectivity to a local area network (LAN), a wide area network (WAN), hotspot, a global communications network, such as the Internet, and so on. The system may be operable to communicate with wired and/or wireless devices or other processing entities using, for example, radio technologies, such as the IEEE 802.xx family of standards, and includes at least Wi-Fi (wireless fidelity), WiMax, and Bluetooth wireless technologies. Communications can be made via a predefined structure as with a conventional network or via an ad hoc communication between at least two devices.

Hardware and software components of the present disclosure, as discussed herein, may be integral portions of a single computer, server, controller, or message sign, or may be connected parts of a computer network. The hardware and software components may be located within a single location or, in other embodiments, portions of the hardware and software components may be divided among a plurality of locations and connected directly or through a global computer information network, such as the Internet. Accordingly, aspects of the various embodiments of the present disclosure can be practiced in distributed computing environments where certain tasks are performed by remote processing devices that are linked through a communications network. In such a distributed computing environment, program modules may be located in local and/or remote storage and/or memory systems.

As will be appreciated by one of skill in the art, the various embodiments of the present disclosure may be embodied as a method (including, for example, a computer-implemented process, a business process, and/or any other process), apparatus (including, for example, a system, machine, device, computer program product, and/or the like), or a combination of the foregoing. Accordingly, embodiments of the present disclosure may take the form of an entirely hardware embodiment, an entirely software embodiment (including firmware, middleware, microcode, hardware description languages, etc.), or an embodiment combining software and hardware aspects. Furthermore, embodiments of the present disclosure may take the form of a computer program product on a computer-readable medium or computer-readable storage medium, having computer-executable program code embodied in the medium, that define processes or methods described herein. A processor or processors may perform the necessary tasks defined by the computer-executable program code. Computer-executable program code for carrying out operations of embodiments of the present disclosure may be written in an object oriented, scripted or unscripted programming language such as Java, Perl, PHP, Visual Basic, Smalltalk, C++, or the like. However, the computer program code for carrying out operations of embodiments of the present disclosure may also be written in conventional procedural programming languages, such as the C programming language or similar programming languages. A code segment may represent a procedure, a function, a subprogram, a program, a routine, a subroutine, a module, an object, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

In the context of this document, a computer readable medium may be any medium that can contain, store, communicate, or transport the program for use by or in connection with the systems disclosed herein. The computer-executable program code may be transmitted using any appropriate medium, including but not limited to the Internet, optical fiber cable, radio frequency (RF) signals or other wireless signals, or other mediums. The computer readable medium may be, for example but is not limited to, an electronic, magnetic, optical, electromagnetic, infrared, or semiconductor system, apparatus, or device. More specific examples of suitable computer readable medium include, but are not limited to, an electrical connection having one or more wires or a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device. Computer-readable media includes, but is not to be confused with, computer-readable storage medium, which is intended to cover all physical, non-transitory, or similar embodiments of computer-readable media.

Various embodiments of the present disclosure may be described herein with reference to flowchart illustrations and/or block diagrams of methods, apparatus (systems), and computer program products. It is understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks. Alternatively, computer program implemented steps or acts may be combined with operator or human implemented steps or acts in order to carry out an embodiment of the invention.

Additionally, although a flowchart or block diagram may illustrate a method as comprising sequential steps or a process as having a particular order of operations, many of the steps or operations in the flowchart(s) or block diagram(s) illustrated herein can be performed in parallel or concurrently, and the flowchart(s) or block diagram(s) should be read in the context of the various embodiments of the present disclosure. In addition, the order of the method steps or process operations illustrated in a flowchart or block diagram may be rearranged for some embodiments. Similarly, a method or process illustrated in a flow chart or block diagram could have additional steps or operations not included therein or fewer steps or operations than those shown. Moreover, a method step may correspond to a method, a function, a procedure, a subroutine, a subprogram, etc.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an element may still actually contain such element as long as there is generally no significant effect thereof.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

Additionally, as used herein, the phrase “at least one of [X] and [Y],” where X and Y are different components that may be included in an embodiment of the present disclosure, means that the embodiment could include component X without component Y, the embodiment could include the component Y without component X, or the embodiment could include both components X and Y. Similarly, when used with respect to three or more components, such as “at least one of [X], [Y], and [Z],” the phrase means that the embodiment could include any one of the three or more components, any combination or sub-combination of any of the components, or all of the components.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

1. A high frequency chest wall oscillation system, the system comprising:
a therapy garment;
a pulsator for creating air pulses, wherein the pulsator includes:
an air pulse generator for creating air pulses having a frequency and a pressure; and
a control panel comprising a touchscreen having a display, wherein a user programs a therapy using the touchscreen;
a single hose coupling the pulsator to the therapy garment for communicating air pulses from the pulsator to the therapy garment.

2. The system of claim 1, wherein the user labels the therapy as a Good Day Therapy or a Bad Day Therapy via the touchscreen.

3. The system of claim 1, wherein the therapy is either a Program Therapy or a Ramp Therapy.

4. The system of claim 1, wherein the system further comprises a mobile app, wherein device data is collected during treatment using the high frequency chest wall oscillation system, and wherein the air pulsator communicates the collected device data to the mobile app.

5. The system of claim 1, wherein the pulsator further comprises an accelerometer, wherein the display has an orientation, and wherein the orientation of the display is adjusted based on readings from the accelerometer.

6. The system of claim 1, wherein the pulsator further comprises an ambient light sensor, wherein the touchscreen has a brightness, and wherein the brightness is automatically adjusted based on sensed ambient light.

7. The system of claim 1, wherein the display is customizable to the user.

8. The system of claim 1 wherein the pulsator further includes a housing having an inlet vent and an outlet vent, the housing encasing the air pulse generator provided in a case, a circuit board, a fan, and a motor, and airflow channel gasketing around a circumference of the case, the airflow channel gasketing defining an airflow pathway.

9. The system of claim 8, wherein the airflow pathway is through the inlet vent, over the case along a first side of the airflow channel gasketing, along the circuit board, over the motor, over the case along a second side of the airflow channel gasketing, and out the outlet vent.

10. A high frequency chest wall oscillation system, the system comprising:
a therapy garment;
a pulsator for creating air pulses, wherein the pulsator includes:
an air pulse generator for creating air pulses having a frequency and a pressure;
a control panel comprising a touchscreen having a display, wherein a user programs a therapy using the touchscreen;
wherein the pulsator has wireless connectivity; and
wherein device data is collected during treatment using the high frequency chest wall oscillation system;
a single hose coupling the pulsator to the therapy garment for communicating air pulses from the pulsator to the therapy garment; and
a mobile app, wherein the pulsator communicates the collected device data to the mobile app.

11. The system of claim 10, wherein the device data is stored in the pulsator, in the mobile app, or on a server.

12. The system of claim 10, wherein the device data includes compliance data including at least one of how often the system is being used and what therapy is being used.

13. The system of claim 10, wherein the device data includes fault codes and/or troubleshooting information.

14. The system of claim 10, wherein the mobile app is provided on a mobile device, wherein the mobile app includes a remote control interface and the mobile device may be used as a remote control.

15. The system of claim 14, wherein the mobile app includes a remote control interface and wherein the remote control interface is specific to a type of user of the mobile app.

16. The system of claim 15, wherein the type of user of the mobile app is a patient and wherein the remote control interface enables the user to start the therapy, stop the therapy, pause the therapy, and review device status.

17. The system of claim 10, wherein a medical professional uses a web app to input data including at least one of settings, prescriptions, instructions, and a new therapy, and wherein the data is sent to the mobile app.

18. The system of claim 10, wherein the mobile app reminds a user to use the high frequency chest wall oscillation system.

19. The system of claim 10, wherein the mobile app coordinates with another device to gather health information about a user of the high frequency chest wall oscillation system, wherein the other device measures at least one vital sign including body temperature, pulse rate, respiratory rate, blood pressure, and blood oxygen levels.

20. The system of claim 10, wherein the user labels the therapy as a Good Day Therapy or a Bad Day Therapy via the touchscreen, and wherein the device data includes occurrences of good days and bad days based on therapy selected for use.
